(19) United States
(12) Patent Application Publication
(10) Pub. No.: US 2005/0149412 A1
(43) Pub. Date: Jul. 7, 2005

(54) System and method for capacity management and trading

(76) Inventors: Jen-Lin Chao, Hsinchu (TW); Grace Lin, Palo Alto, CA (US)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/750,751

(22) Filed: Jan. 2, 2004

(51) Int. Cl. G06F 17/60

(52) U.S. Cl. 705/28

(57) ABSTRACT

A system and method for capacity management and trading. The system includes at least a first capacity reserved for a first device design in a first capacity management cycle, a second capacity reserved for a second device design having a pull-in demand in a second capacity management cycle after the first capacity management cycle and a processing unit. The processing unit exchanges the first capacity and the second capacity, such that the first capacity meets the second device design and the second capacity meets the first device design.

### BACKGROUND

The present invention relates to capacity management and particularly to a system and method for managing and trading capacity between clients.

A product supply chain performs the functions of material purchasing, transformation materials into intermediate and finished products, and distribution of finished products to clients. In a supply chain, clients transmit demands that may include a request for a particular quantity of a device design to a supplier by a specific date. The supplier plans its internal or external manufacturing schedule according to these received demands, and allocates capacity for manufacturing products to satisfy each client.

Effective supply chain management is crucial to meet goals of reduced inventory, increased productivity, and improved competitiveness. Manufacturing and distribution facilities have limited resources and capacity. That is, not every client request may be met, in that some may be promised but unfulfilled, some may receive inadequate supply, and others may be rejected. Consequently, effective management of capacity in supply chain management, without excess capacity loss, has become an important aspect for a product supplier needing to control manufacturing or distribution.

There is a relatively unique business model in which a supplier prepares its capacity (capacity available support demand, CASD) for respective clients based on client demand plans (client forecast plans), and utilizes its capacity based on both the demand plans and actual orders. In this model, the supplier, instead of the client, is exposed to the risk of market fluctuation. The clients benefit from the long-term contract business model and the shift of market fluctuation risk to the supplier. Although the supplier is exposed to greater risk, clients receive better service.

FIG. 1 illustrates a capacity management cycle 100, including four periods: CASD preparation period P1, CASD operation period P2, open period P3, and production period P4. During CASD preparation period P1, each client transmits its forecast demand plans to the supplier, and reserves capacity to fulfill its forecast demand plans. Subsequent to the CASD preparation period P1, the CASD for the respective client is fixed. During CASD operation period P2, the supplier receives actual orders from the client, and allocates appropriate capacity from the reserved CASD. After a cut off date (COD) for the capacity management cycle, the remnant CASD of each client is released. The released capacity is then opened and follows the first in first serve (FIFS) rule to fulfill all orders received from other clients during open period P3. After the open period P3, the supplier begins manufacturing products for a respective client using its reserved CASD during production period P4.

In the CASD model, if precise capacity management is achieved, the supplier gains advantage over competitors attempting to serve the same clients. However, since the open period P3 is short, and clients always wait until the cut off date to give up its CASD, capacity management becomes inefficient, and the supplier may lose capacity, thereby reducing the capacity utility rate, and increasing related costs and risk.

### SUMMARY

The present invention is proposed to solve the aforementioned issues. It is noted that the present invention will be applicable to any factory, service supplier and product.

Accordingly, it is an object of the present invention to provide a system and method for capacity management.

It is another object of the present invention to provide a system and method for trading capacity between clients.

To achieve the above objects, the present invention provides a system and method for capacity management and trading. According to one embodiment of the invention, the system includes a user interface, a processing unit and an accounting unit. The user interface receives a capacity release request having a first capacity reserved in a first capacity management cycle from a first client, and a pull-in demand from a second client via a network, in which client information is kept confidential. The processing unit releases the first capacity to meet the pull-in demand if the first capacity is sufficient for the pull-in demand. The accounting unit generates a bill for the pull-in demand to the second client, and calculates a product discount for the first client.

The system further includes a reservation unit for reserving a second capacity originally reserved for the pull-in demand for a device design corresponding to the first capacity in a second capacity management cycle after the first capacity management cycle releases a first capacity.

The processing unit further defines a capacity push-out ratio for the first client, in which the first capacity is under the push-out ratio, and transmits a notification to the first client, in which the notification comprises the cycle time of the second capacity management cycle and completion date for the products of the first client.

According to another embodiment of the invention, the method first receives a capacity release request having a first capacity reserved in a first capacity management cycle and a pull-in demand from a first client and a second client via a network, respectively. The client information is kept confidential. If the first capacity is sufficient for the pull-in demand, the first capacity is released to meet the pull-in demand. A bill for the pull-in demand is then generated and transmitted to the second client, and a product discount is calculated for the first client.

The method further reserves a second capacity originally reserved for the pull-in demand for a device design corresponding to the first capacity in a second capacity management cycle after the first capacity management cycle releases a first capacity.

The method further defines a capacity push-out ratio for the first client, in which the first capacity is under the push-out ratio, and transmits a notification to the first client, in which the notification comprises the cycle time of the second capacity management cycle and completion date for the products of the first client.

The above-mentioned method may take the form of program code embodied in a tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the capacity management cycle;

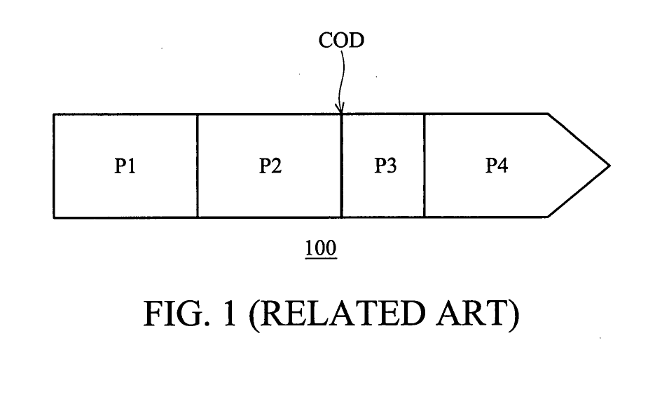

FIG. 2 is a schematic diagram illustrating capacity trading according to the present invention;

FIG. 3 is a schematic diagram illustrating the system architecture of the capacity trading system according to the present invention;

FIG. 4 is a flowchart showing the process of the capacity management method according to the present invention; and

FIG. 5 is a schematic diagram illustrating a storage medium for storing a computer program for execution of the capacity trading method according to the present invention.

### DESCRIPTION

The present invention provides a system and method overcoming conventional capacity management problems.

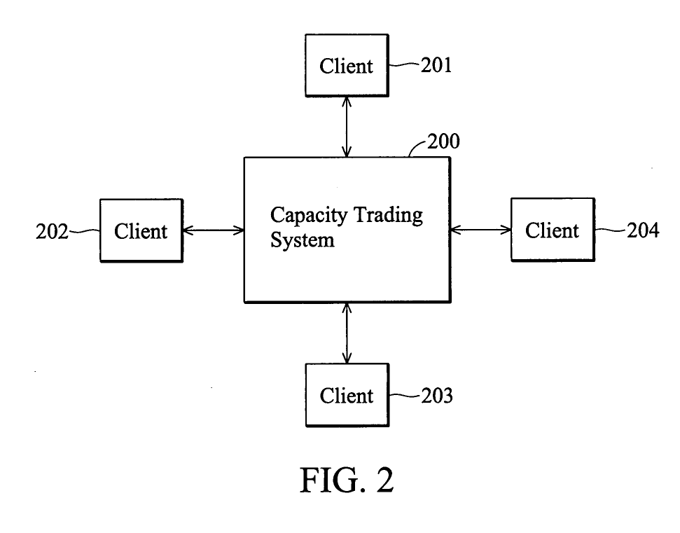

FIG. 2 is a schematic diagram illustrating capacity trading according to the present invention. As shown in FIG. 2, clients 201, 202, 203 and 204 may use the capacity trading system 200 of the present invention as a platform to trade reserved capacity. It should be noted that information of each client is kept confidential and maintained in secrecy from other clients by the capacity trading system 200.

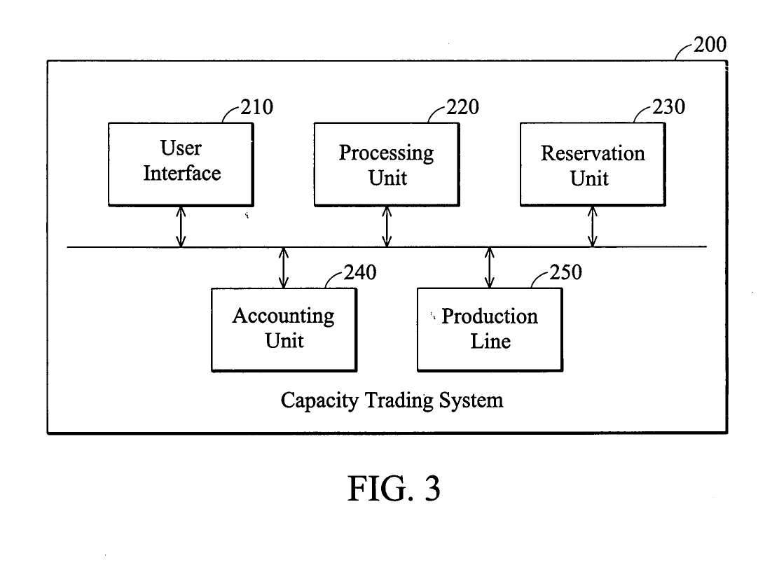

FIG. 3 illustrates the architecture of the capacity trading (management) system 200 according to the embodiment of the present invention. The capacity trading system 200 includes a user interface 210, a processing unit 220, a reservation unit 230, an accounting unit 240 and a production line 250. The user interface 210 may be a web-based interface, receiving information, such as capacity release requests and pull-in demands from clients via a network. The processing unit 220 defines a capacity push-out ratio for each client, and each client may release its capacity accordingly. The processing unit 220 performs the capacity management method according to the present invention, and is described in detail in the followings.

Clients may use the reservation unit 230 to reserve capacity. Additionally, the reservation unit 230 also receives direction from the processing unit 220 to reserve and exchange capacity between clients. The accounting unit 240 generates capacity trading bills for buyers, and calculates product discounts for sellers. The production line 250 manufactures products according to device designs from each client using corresponding reserved capacity when one capacity management cycle is complete.

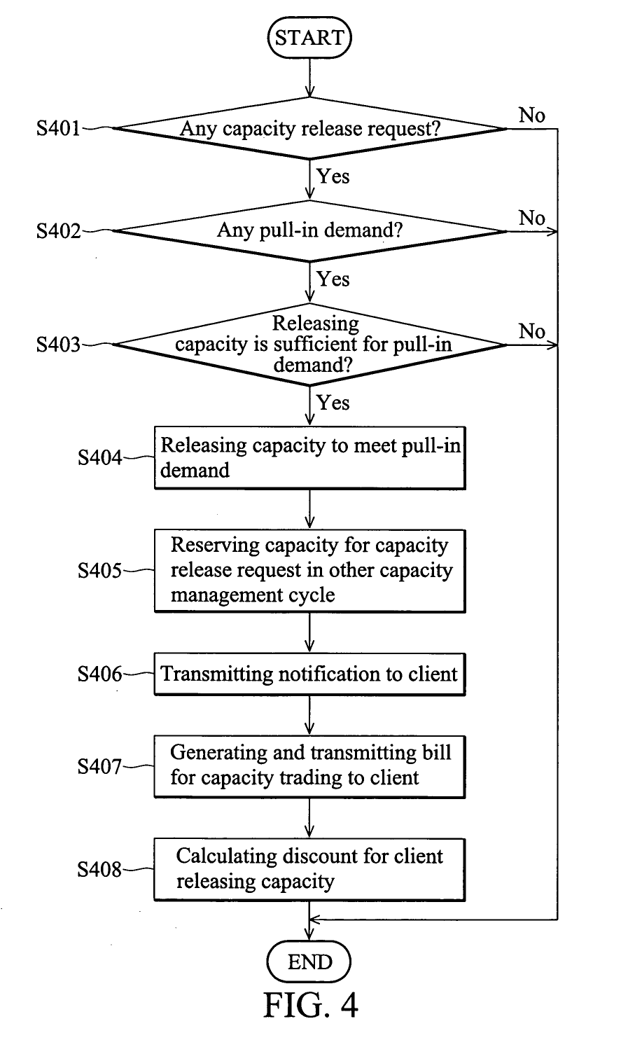

FIG. 4 shows the process of the capacity management method according to the embodiment of the present invention.

In step S401, the processing unit 220 checks whether any capacity release requests have been received. If not, the procedure is complete. If a capacity release request has been received in the CASD operation period of a capacity management cycle (Yes in step S401), in step S402, the processing unit 220 checks whether any pull-in demand exists. If no pull-in demand exists, the procedure is complete. It is understood that the processing unit 220 may continue to perform the operation of step S402 until the end of the CASD operation period of the capacity management cycle.

If there a pull-in demand exists or is received (Yes in step S402), in step S403, the processing unit 220 checks whether the released capacity recorded in the capacity release request is sufficient to meet the pull-in demand. If the released capacity is not sufficient to meet the pull-in demand, the procedure is complete. Similarly, the processing unit 220 may continue to perform the operations of steps S401, S402 and S403 if other capacity release requests or pull-in demands are received until the end of the CASD operation period of the capacity management cycle.

If so (Yes in step S403), in step S404, the processing unit 220 releases the capacity recorded in the capacity release request to meet the pull-in demand, and in step S405, reserves capacity (future capacity) for the released capacity of the capacity release request in another capacity management cycle. In another aspect, the processing unit 220 may exchange the capacity of the capacity release request and that of the pull-in demand if the pull-in demand has its own capacity reserved in a specific capacity management cycle.

In step S406, the processing unit 220 transmits notifications to respective clients. The notification sent to a client releasing capacity includes cycle time of the exchanged capacity management cycle and the product completion date. The notification sent to the client requesting the pull-in demand includes cycle time of the pull-in capacity management cycle and product completion date. Thereafter, in step S407, the processing unit 220 directs the accounting unit 240 to generate a bill for the capacity trading and transmits it to the client requesting the pull-in demand via the network. Additionally, in step S408, the accounting unit 240 further calculates a product discount for the client releasing capacity. It is understood that the production line 250 may begin manufacturing specific products according to the pull-in demand using released capacity subsequent to the pull-in capacity management cycle, and manufacture other products for the client releasing capacity using the specially released capacity subsequent to the exchanged capacity management cycle.

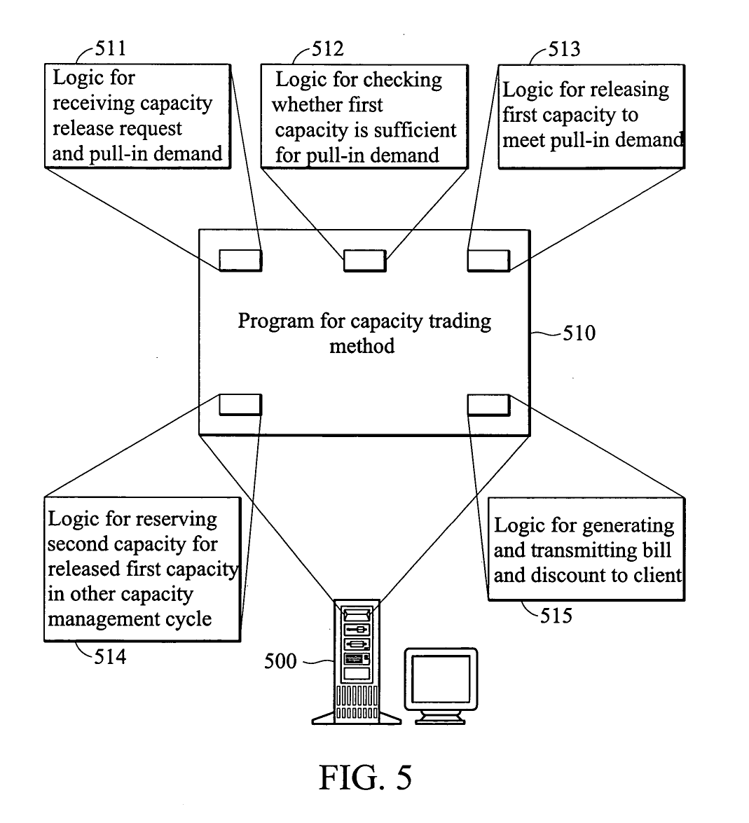

FIG. 5 is a diagram of a storage medium for storing a computer program providing the capacity trading method according to the present invention. The computer program product comprises a storage medium 510 having computer readable program code embodied in the medium for use in a computer system 500, the computer readable program code comprising at least computer readable program code 511 receiving a capacity release request and a pull-in demand, in which the capacity release request includes a first capacity reserved in a first capacity management cycle, computer readable program code 512 checking whether the first capacity is sufficient for the pull-in demand, computer readable program code 513 releasing the first capacity to meet the pull-in demand if the first capacity is sufficient for the pull-in demand, computer readable program code 514 reserving a second capacity for a device design corresponding to the first capacity in a second capacity management cycle, and computer readable program code 514 generating and transmitting a bill and a discount to clients.

The present invention provides suppliers a mechanism for properly managing and fully utilizing their capacity, thereby reducing capacity loss, and improving the effectiveness of supply chain management. Additionally, the present invention provides clients a business platform for trading capacity, such that last minute unplanned capacity is supported without impacting the scheduled production plan of the supply chain management system.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A system for capacity management, comprising:
a first capacity reserved for a first device design in a first capacity management cycle;
a second capacity reserved for a second device design having a pull-in demand in a second capacity management cycle after the first capacity management cycle; and
a processing unit to exchange the first capacity and the second capacity, wherein the processing unit directs the first capacity to meet the second device design and the second capacity to meet the first device design.

2. The system of claim 1 further comprising a production line to manufacture the second device design using the first capacity after the first capacity management cycle.

3. The system of claim 2 wherein the production line further manufactures the first device design using the second capacity after the second capacity management cycle.

4. The system of claim 1 wherein the processing unit further checks whether the first capacity reserved for the first device design is sufficient for the second capacity reserved for the second device design.

5. The system of claim 1 further comprising a reservation unit for reserving capacity in the first and second capacity management cycles.

6. The system of claim 5 wherein the first capacity is reserved by a first client and the second capacity is reserved by a second client.

7. A method for capacity management, comprising the steps of:
exchanging a first capacity reserved for a first device design in a first capacity management cycle with a second capacity reserved for a second device design in a second capacity management cycle after the first capacity management cycle, in which the second device design has a pull-in demand;
such that the first capacity meets the second device design and the second capacity meets the first device design.

8. The method of claim 7 further comprising manufacturing the second device design using the first capacity after the first capacity management cycle.

9. The method of claim 8 further comprising manufacturing the first device design using the second capacity after the second capacity management cycle.

10. The method of claim 7 further comprising checking whether the first capacity reserved for the first device design is sufficient for the second capacity reserved for the second device design.

11. The method of claim 7 further comprising reserving capacity in the first and second capacity management cycles for the first and second device designs respectively.

12. The method of claim 11 wherein the first capacity is reserved by a first client and the second capacity is reserved by a second client.

13. A machine-readable storage medium storing a computer program which when executed causes a computer to perform a method for capacity management, the method comprising the steps of:
exchanging a first capacity reserved for a first device design in a first capacity management cycle with a second capacity reserved for a second device design in a second capacity management cycle after the first capacity management cycle, in which the second device design has a pull-in demand,
such that the first capacity meets the second device design and the second capacity meets the first device design.

14. The storage medium of claim 13 wherein the method further comprises a step of manufacturing the second device design using the first capacity after the first capacity management cycle.

15. The storage medium of claim 14 wherein the method further comprises a step of manufacturing the first device design using the second capacity after the second capacity management cycle.

16. The storage medium of claim 13 wherein the method further comprises a step of checking whether the first capacity reserved for the first device design is sufficient for the second capacity reserved for the second device design.

17. The storage medium of claim 13 wherein the method further comprises a step of reserving capacity in the first and second capacity management cycles for the first and second device designs respectively.

18. The storage medium of claim 17 wherein the first capacity is reserved by a first client and the second capacity is reserved by a second client.

19. A capacity trading system, comprising:
a user interface to receive a capacity release request and a pull-in demand, in which the capacity release request comprises a first capacity reserved in a first capacity management cycle;
a processing unit coupled to the user interface to receive the capacity release request and the pull-in demand, and release the first capacity to meet the pull-in demand; and
an accounting unit to generate a bill for the pull-in demand.

20. The system of claim 19 further comprising a production line to manufacture products for the pull-in demand using the first capacity after the first capacity management cycle.

21. The system of claim 19 wherein the processing unit further checks whether the first capacity is sufficient for the pull-in demand.

22. The system of claim 19 further comprising a reservation unit to reserve a second capacity for a device design corresponding to the first capacity in a second capacity management cycle behind the first capacity management cycle when the first capacity is released.

23. The system of claim 22 further comprising a production line to manufacture products for the device design using the second capacity after the second capacity management cycle.

24. The system of claim 19 wherein the capacity release request is received from a first client and the pull-in demand is received from a second client via a network, in which information of the first and second clients is kept confidential by the capacity trading system.

25. The system of claim 24 wherein the accounting unit further transmits the bill to the second client.

26. The system of claim 24 wherein the accounting unit further calculates a discount for the products of the first client.

27. The system of claim 24 wherein the processing unit further transmits a notification to the first client, in which the notification comprises cycle time of the second capacity management cycle and completion date for the products of the first client.

28. The system of claim 24 wherein the processing unit further defines a capacity push-out ratio for the first client, and the first capacity follows accordingly.

29. The system of claim 22 wherein the second capacity is originally reserved for the pull-in demand.

30. A capacity trading method, comprising the steps of:
receiving a capacity release request, in which the capacity release request comprises a first capacity reserved in a first capacity management cycle;
receiving a pull-in demand;
releasing the first capacity to meet the pull-in demand; and
generating a bill for the pull-in demand.

31. The method of claim 30 further comprising manufacturing products for the pull-in demand using the first capacity after the first capacity management cycle.

32. The method of claim 30 further comprising checking whether the first capacity is sufficient for the pull-in demand.

33. The method of claim 30 further comprising reserving a second capacity for a device design corresponding to the first capacity in a second capacity management cycle after the first capacity management cycle when the first capacity is released.

34. The method of claim 33 further comprising manufacturing products for the device design using the second capacity after the second capacity management cycle.

35. The method of claim 30 wherein the capacity release request is received from a first client and the pull-in demand is received from a second client via a network, in which information of the first and second clients is kept confidential.

36. The method of claim 35 further comprising transmitting the bill to the second client.

37. The method of claim 35 further comprising calculating a discount for the products of the first client.

38. The method of claim 35 further comprising transmitting a notification to the first client, in which the notification comprises cycle time of the second capacity management cycle and completion date for the products of the first client.

39. The method of claim 35 further comprising defining a capacity push-out ratio for the first client, and the first capacity follows accordingly.

40. The method of claim 33 wherein the second capacity is originally reserved for the pull-in demand.

41. A machine-readable storage medium storing a computer program which when executed causes a computer to perform a capacity trading method, the method comprising the steps of:
receiving a capacity release request and a pull-in demand, in which the capacity release request comprises a first capacity reserved in a first capacity management cycle;
releasing the first capacity to meet the pull-in demand; and
generating a bill for the pull-in demand.

42. The storage medium of claim 41 wherein the method further comprises a step of manufacturing products for the pull-in demand using the first capacity after the first capacity management cycle.

43. The storage medium of claim 41 wherein the method further comprises a step of checking whether the first capacity is sufficient for the pull-in demand.

44. The storage medium of claim 41 wherein the method further comprises a step of reserving a second capacity for a device design corresponding to the first capacity in a second capacity management cycle behind the first capacity management cycle when the first capacity is released.

45. The storage medium of claim 44 wherein the method further comprises a step of manufacturing products for the device design using the second capacity after the second capacity management cycle.

46. The storage medium of claim 41 wherein the capacity release request is received from a first client and the pull-in demand is received from a second client via a network, in which information of the first and second clients is kept confidential.

47. The storage medium of claim 46 wherein the method further comprises a step of transmitting the bill to the second client.

48. The storage medium of claim 46 wherein the method further comprises a step of calculating a discount for the products of the first client.

49. The storage medium of claim 46 wherein the method further comprises a step of transmitting a notification to the first client, in which the notification comprises cycle time of the second capacity management cycle and completion date for the products of the first client.

50. The storage medium of claim 46 wherein the method further comprises a step of defining a capacity push-out ratio for the first client, and the first capacity follows accordingly.

51. The storage medium of claim 44 wherein the second capacity is originally reserved for the pull-in demand.

52. A method for capacity management, comprising the steps of:
receiving a capacity release request, in which the capacity release request comprises a first capacity reserved in a first capacity management cycle;
receiving a pull-in demand; and
releasing the first capacity to meet the pull-in demand.

53. The method of claim 52 further comprising checking whether the first capacity is sufficient for the pull-in demand.

54. The method of claim 52 further comprising reserving a second capacity for a device design corresponding to the first capacity in a second capacity management cycle behind the first capacity management cycle when the first capacity is released.

55. A machine-readable storage medium storing a computer program which when executed causes a computer to perform a capacity management method, the method comprising the steps of:
receiving a capacity release request, in which the capacity release request comprises a first capacity reserved in a first capacity management cycle;
receiving a pull-in demand; and
releasing the first capacity to meet the pull-in demand.

56. The storage medium of claim 55 wherein the method further comprises a step of checking whether the first capacity is sufficient for the pull-in demand.

57. The storage medium of claim 55 wherein the method further comprises a step of reserving a second capacity for a device design corresponding to the first capacity in a second capacity management cycle behind the first capacity management cycle when the first capacity is released.
